(19) United States
(12) Patent Application Publication
(10) Pub. No.: US 2016/0013680 A1
(43) Pub. Date: Jan. 14, 2016

(54) WIRELESS CHARGING BATTERY AND CORRESPONDING ELECTRIC DEVICE

(71) Applicants: CHAMP TECH OPTICAL (FOSHAN) CORPORATION, Foshan (CN); FOXCONN TECHNOLOGY CO., LTD., New Taipei (TW)

(72) Inventors: LONG-QING LIANG, Foshan (CN); DI-QIONG ZHAO, Foshan (CN); QIU-RI ZHANG, New Taipei (TW); CHIH-FENG HU, New Taipei (TW); YUNG-PING LIN, New Taipei (TW)

(21) Appl. No.: 14/678,405

(22) Filed: Apr. 3, 2015

(30) Foreign Application Priority Data
Jul. 11, 2014 (CN) 201410329837.0

(51) Int. Cl. H02J 7/02

(52) U.S. Cl. CPC H02J 7/025

(57) ABSTRACT

A wireless charging battery includes a battery module, a circuit mounted on an end of the battery module, a signal receiving unit located on a side of the battery module, and a signal controlling unit located at an opposite side of the battery module and coupled with the circuit. A plurality of ports is formed on a top side of the circuit, the signal receiving unit and the signal controlling unit are arranged independently. The signal controlling unit has a plurality of contacting points. An electric device having the wireless charging battery is also provided.

### CROSS-REFERENCE TO RELATED APPLICATIONS

This application claims priority to Chinese Patent Application No. 201410329837.0 filed on Jul. 11, 2014 in the State Intellectual Property Office of the P. R. C, the contents of which are incorporated by reference herein.

### FIELD

The subject matter herein generally relates to a wireless charging battery and an electric device having the wireless charging battery.

### BACKGROUND

A device having wireless charging function includes a wireless charging module. The wireless charging module is housed by the device.

### BRIEF DESCRIPTION OF THE DRAWINGS

Implementations of the present technology will now be described, by way of example only, with reference to the attached figures.

FIG. 1 is an isometric view of a wireless charging battery of an embodiment of the present disclosure.

FIG. 2 is an exploded view of the wireless charging battery of FIG. 1.

FIG. 3 is an isometric view of an electric device having the wireless charging battery of FIG. 1.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. The description is not to be considered as limiting the scope of the embodiments described herein.

Several definitions that apply throughout this disclosure will now be presented. The term “comprising” means “including, but not necessarily limited to”; it specifically indicates open-ended inclusion or membership in a so-described combination, group, series and the like. The term “coupled” is defined as connected, whether directly or indirectly through intervening components, and is not necessarily limited to physical connections. The connection can be such that the objects are permanently connected or releasably connected. The term “electronically coupled” can include any coupling that is via a wired or wireless connection. The electronic coupling can be through one or more components or it can include a direct connection between the described components.

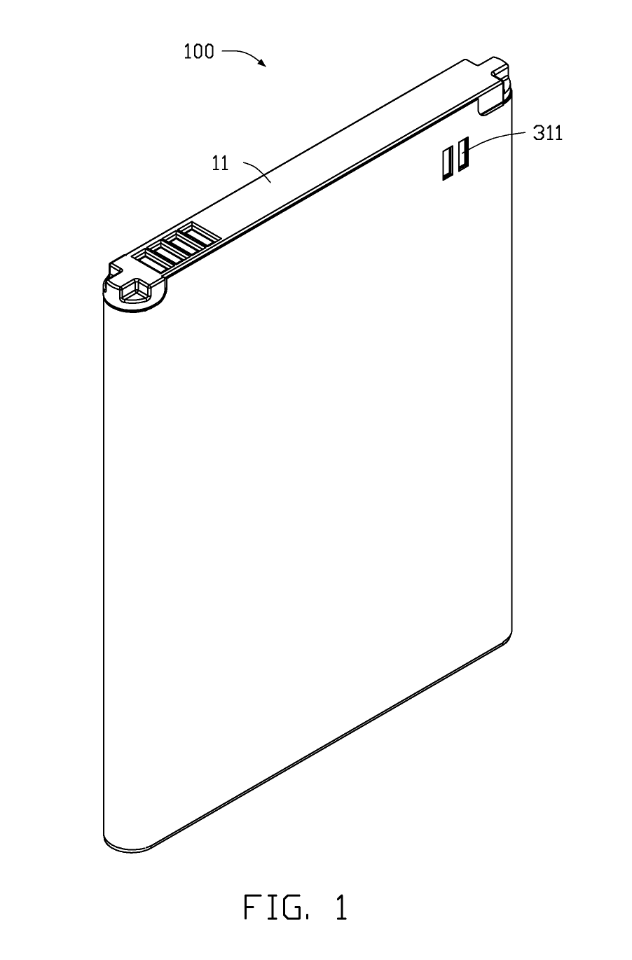

Referring to FIGS. 1-3, a wireless charging battery 100 and a corresponding electric device 60 including the wireless charging battery 100 are shown.

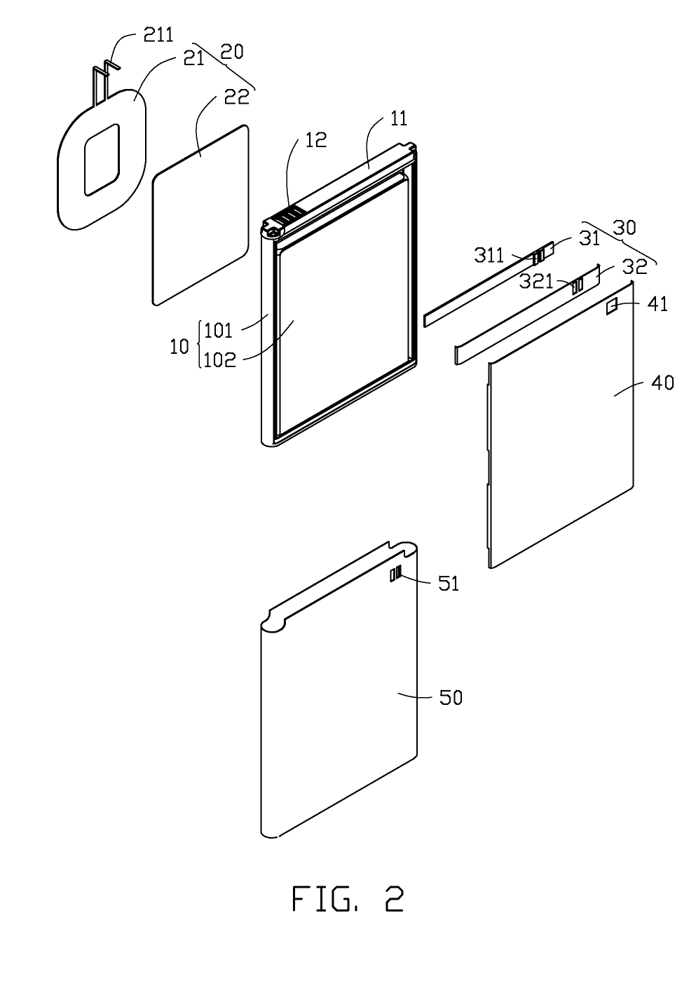

Referring to FIGS. 1-2, the wireless charging battery 100 includes a battery module 10, a signal receiving unit 20, a signal controlling unit 30, a cover 40 and a housing 50. The signal receiving unit 20 and the signal controlling unit 30 are located at opposite sides of the battery module 10 respectively. The cover 40 engages with the battery module 10 to make the signal controlling unit 30 be received in a space between the battery module 10 and the cover 40. The housing 50 houses the battery module 10, the signal receiving unit 20, the signal controlling unit 30 and the cover 40 therein.

In this embodiment, the battery module 10 is substantially rectangular. The battery module 10 includes a frame 101 and a energy storage 102 received in the frame 101. A circuit 11 is mounted on a top end of the frame 101 and is coupled with the energy storage 102. A plurality of ports 12 is formed on a top side of the circuit 11 to contact with the electric device 60. The energy storage 102 stores electric energy from external power source. The energy storage 102 of the battery module 10 exchanges the electric energy with the electric device 60 through the plurality of the ports 12. It is means that the plurality of ports 12 can be used to recharge the battery module 10, and also can be used to output de electric energy of the energy storage 102 of the battery module 10 to the electric device 60 coupled to the plurality of ports 12.

The signal receiving unit 20 comprises a coil 21 and a wall 22. The signal receiving unit 20 can be fixed to a side of the battery module 10 by gules or by a way of magnetic adsorption. The coil 21 is fixed on a side of the wall 22 and senses environmental magnetic signals. The wall 22 is located between the coil 21 and the battery module 10 to optimize magnetic signals received by the coil 21. The coil 21 further comprises a coupling arm 211 coupled to the signal controlling unit 30. In the other embodiment, the signal receiving unit 20 can comprise multiple coils 21 fixed on a side of the wall 22, and a shape of every coil 21 is different.

The signal controlling unit 30 is located opposite to the signal receiving unit 20 and is adjacent to the circuit 11. The signal controlling unit 30 is coupled with the circuit 11. The signal controlling unit 30 comprises a body 31 and a cover 32 covering the body 31. A plurality of contacting points 311 are fixed on a side of the body 31 and a plurality of openings 321 is defined accordingly in the cover 32. The signal controlling unit 30 is used to exchange and modulate induced currents from the signal receiving unit 20 and conduct the induced currents to the battery module 10 through the circuit 11.

In this embodiment, the cover 40 is substantially rectangular. A through hole 41 is defined in a side of the cover 40. The through hole 41 corresponds with the plurality of contacting points 311.

The housing 50 is configured on the outmost surface of the battery module 10. A plurality of holes 51 is defined in a side of the housing 50. The holes 51 are corresponding with the contacting points 311 and the through holes 41. The contacting points 311 extend through the through hole 41 and the hole 51 is exposed out of the housing 50.

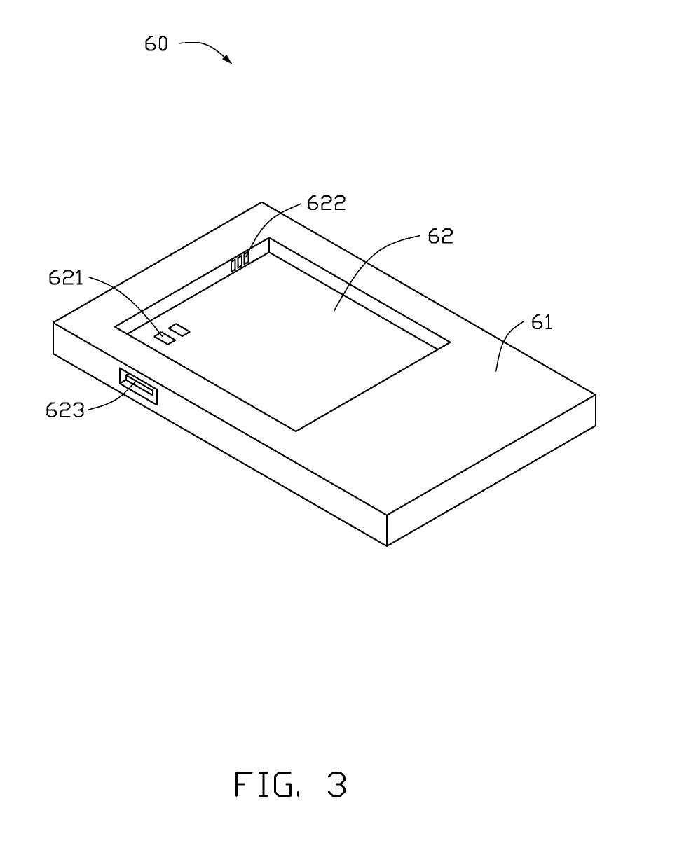

Referring to the FIG. 3, the electric device 60 can collocate with the wireless charging battery 100. The electric device 60 comprises a main portion 61. A groove 62 is defined in a side of the main portion 61. The groove 62 receives the wireless charging battery 100 therein. A plurality of first access points 621 is formed on a bottom of the groove 62, a plurality of second access points 622 is formed on an end of the groove 12. The first access points 621 and the second access points 622 are corresponding to the contacting points 311 and the ports 12 respectively. The wireless charging battery 100 can be placed in the groove 62 and the wireless charging battery 100 is coupled with the electric device 60 through the first access points 621 attaching to the contacting points 311 of the signal controlling unit 30 and the second access points 622 attaching to the ports 12 of the circuit 11. An input 623 is formed on an end of the main portion 61 and is coupled with the first access points 621 and the second access points 622. In this disclosure, the input 623 is a Universal Serial Bus and coupled to the inside circuit of the electric device 60, the electric device 60 is portable device, such as a cell phone or an iPad.

In this embodiment, the wireless charging battery 100 can be charged by a wire-charging way or by a wireless charging way. When the wireless charging battery 100 is charged by a wire-charging way, the wireless charging battery 100 is exposed from the electric device 60. If the wireless charging battery 100 is exposed from the device 60, the user can usually use a data line to connect a power source with the input 623 of the electric device 60 to charge the wireless charging battery 100.

When the wireless charging battery 100 is charged by a wireless way, the wireless charging battery 100 is received in the groove 62 of the electric device 60. The signal receiving unit 20 receives magnetic signals from an external power source sending magnetic signals, and the coil 21 of the receiving unit 20 senses magnetic signals and converts the magnetic signals to induced current. The induced current from the signal receiving unit 20 was conducted to the signal receiving unit 30 by the coupling arm 211 of the receiving unit 20. Then the induced current was conducted from the conducting points 311 to the first access points 621, from the first access points 621 to the input 623, from the input 623 to the second access points 622, and from the second access points 622 to the ports 12 of the wireless charging battery 100. Lastly, the induced currents enter the circuit 11 to charge the battery module 10 of the wireless charging battery 100 through the ports 12.

Alternatively, the wireless charging battery 100 can be charged by a wire-charging way or by a wireless-charging way. The signal receiving controlling unit 30 and the circuit 11 are arranged independently to avoid the signal receiving unit 20 and the signal controlling unit 30 from impacting the circuit 11. The process of the wireless-charging way charges the wireless charging battery 100 through the input 623; it is equivalent to the process of the wire-charging way and has a good compatibility.

The embodiments shown and described above are only examples. Many details are often found in the art such as the other features of the wireless charging battery and corresponding electric device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A wireless charging battery, comprising:
a battery module;
a circuit mounted on a top end of the battery module;
a signal receiving unit located on a side of the battery module; and
a signal controlling unit located on a side of the battery module and coupled with the circuit;
wherein a plurality of ports is formed on a top side of the circuit, the signal receiving unit and the signal controlling unit are arranged independently, the signal controlling unit has a plurality of contacting points.

2. The wireless charging battery of claim 1, wherein the signal controlling is located opposite to the signal receiving unit and is adjacent to the circuit.

3. The wireless charging battery of claim 1, wherein the signal controlling unit includes a body and a cover covering the body.

4. The wireless charging battery of claim 3, wherein the plurality of contacting points is fixed on a side of the body.

5. The wireless charging battery of claim 3, wherein a plurality of openings is defined in the cover accordingly with the plurality of contacting points.

6. The wireless charging battery of claim 1, wherein the signal receiving unit includes a wall and a coil fixed on a side of the wall.

7. The wireless charging battery of claim 6, wherein the coil further includes a coupling arm, the coupling arm is coupled to the signal controlling unit.

8. The wireless charging battery of claim 1, wherein the signal receiving unit includes a wall and multiple coils fixed on a side of the wall.

9. The wireless charging battery of claim 8, wherein every coil has different shape.

10. The wireless charging battery of claim 1, wherein a cover is also included, the cover is engaged with the battery module to cover the signal controlling unit in space between the battery module and the cover.

11. The wireless charging battery of claim 10, wherein a through hole is defined in a side of the cover and is corresponding with the contacting points, the contacting points extend through the through hole.

12. The wireless charging battery of claim 1, wherein a housing is further included, the housing houses the battery module, the signal receiving unit and the signal controlling unit therein.

13. The wireless charging battery of claim 12, wherein a plurality of hole is defined in a side of the housing, the contacting points extends through the hole and is exposed out of the housing.

14. An electric device comprising:
a main portion;
a groove defined in a side of the main portion; and
a wireless charging battery received in the groove;
wherein the wireless charging battery comprising a battery module, a circuit mounted on a top end of the battery module, a signal receiving unit located on a side of the battery module, and a signal controlling unit located opposite to the signal receiving unit and coupled with the circuit; and
wherein a plurality of ports is formed on a top side of the circuit, the signal receiving unit and the signal controlling unit are arranged independently, the signal controlling unit has a plurality of contacting points.

15. The electric device of claim 14, wherein a plurality of first access points is formed on the bottom of the groove and a plurality of second access points is formed in an end of the groove.

16. The electric device of claim 15, wherein the first access points attaches the contacting points and the second access points attaches the ports of the circuit.

17. The electric device of claim 14, wherein the signal controlling unit is located opposite to the signal receiving unit and is adjacent to the circuit.

18. The electric device of claim 14, wherein signal controlling unit includes a body and a cover covering the body.

19. The electric device of claim 18, wherein the contacting points is fixed on a side of the body.

20. The electric device of claim 18, wherein a plurality of openings is defined in the cover accordingly with the contacting points.
